(19) United States
(12) Patent Application Publication
(10) Pub. No.: US 2010/0179823 A1
(43) Pub. Date: Jul. 15, 2010

(54) ONLINE DESIGN DECISION MANAGEMENT

(75) Inventors: BRIAN R. CARTER, KANSAS CITY, MO (US); TROY J. MILLER, KANSAS CITY, MO (US); MICHAEL HOURIGAN, LEE'S SUMMIT, MO (US); BRADLEY W. ARNOLD, LIBERTY, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/390,122

(22) Filed: Feb. 20, 2009

Related U.S. Application Data
(60) Provisional application No. 61/143,666, filed on Jan. 9, 2009.

(51) Int. Cl. G06Q 50/00; G06F 17/30

(52) U.S. Cl. 705/2; 707/E17.032

(57) ABSTRACT

Methods, computer-readable media, and systems provide design decision management (DDM) to manage the various design decisions made by a client healthcare provider during the design of a healthcare management system by a solution-provider company. A DDM system provides a user interface and allows a user to access data from design decision databases, analyze accessed data, and conduct design review of client design decisions. Design review is initiated when a client design decision conflicts with a company-recommended design decision. The design review process determines if the conflicting client design decision should be approved and implemented or if the company-recommended design decision should be implemented.

### CROSS-REFERENCE TO RELATED APPLICATIONS

This application claims the benefit of U.S. Provisional Application No. 61/143,666, filed Jan. 9, 2009.

### BACKGROUND

Computer systems are increasingly being adapted to automate or facilitate performance of manual tasks. When computer systems are implemented in this way on an institutional level, a number of design decisions must be made when designing the computer systems to correctly configure and implement the computer systems. A design management system can facilitate institutional computer system configuration and ensure that design decisions are made correctly.

The health care industry in particular has embraced computer systems to automate and facilitate patient care in recent years. Computerized management of caregiver instructions, patient records, and other health care information reduces errors, increases efficiency, and improves the overall quality of patient care.

### SUMMARY

The present invention generally relates to design decision management (DDM) methods, computer-readable media, and systems for implementing computerized systems on an institutional level in a healthcare setting.

In one embodiment, a DDM system or method may be implemented to ensure correct configuration of a computerized health care management system. The DDM system or method may manage all individual design decisions for a particular implementation. For example, the DDM system or method may manage one particular hospital's implementation of a health care management system. In other embodiments, the DDM system or method may manage individual design decisions for a plurality of health care management systems. In various embodiments, the DDM system or method may be implemented in a network.

The DDM system or method may display design decisions to be made, listed individually, categorically, or both, along with the status of each design decision. Design decisions may have a recommended configuration. The DDM system or method may also require review of decisions before acceptance. If a design decision is made that conflicts with a recommended configuration, the DDM system or method may alert responsible parties of the conflict, possibly by email.

In another embodiment, design decisions requiring review or design decisions that have not yet been made may be presented separately. In a further embodiment, the DDM system or method may analyze configurations of a plurality of health care management systems and identify design decision recommendations that are frequently not followed.

In a further embodiment, the DDM system or method may alert a manager, possibly by email, that a particular design decision recommendation is not being followed and assign a review task to a reviewer. The task reviewer may assign another responsible party to discuss the situation with a representative of the owner of the health care management system.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram illustrating components of a design decision management system in accordance with an embodiment of the invention;

FIG. 3 is an illustrative screen display showing an exemplary user interface for a design decision matrix in accordance with an embodiment of the present invention;

FIG. 4 is an illustrative screen display showing an exemplary user interface for a dashboard reporting view of the design decision process in accordance with an embodiment of the present invention;

FIG. 5 is an illustrative screen display showing an exemplary user interface for viewing and editing details of a design decision in accordance with an embodiment of the present invention;

FIG. 6 is a flow diagram showing a method for conducting design decision review in accordance with an embodiment of the present invention; and

FIG. 7 is a flow diagram showing a method for conducting design decision review in accordance with an embodiment of the present invention.

### DETAILED DESCRIPTION

The health care industry is becoming increasingly reliant upon computerized patient care management. Computers can be used to track patient records, communicate information between central records systems and patient-specific devices, provide up-to-date information to medical professionals as they treat patients, and keep track of current patient medications and allergies, among other things. As part of this continued trend toward automation, a hospital, clinic, or other healthcare provider may select a company to customize a software and hardware design solution (healthcare management system) that will meet the specific needs of that particular healthcare provider. The terms “healthcare provider,” “client,” “client healthcare provider,” and “customer” are used interchangeably herein to refer to a provider of healthcare services who employs the services of a company to customize a healthcare management system for the healthcare provider. As used herein, the terms “solution-provider company” and “company” are used interchangeably herein to refer to the company that provides customized healthcare management solutions to the healthcare provider.

Companies offering healthcare management systems may offer a variety of products, systems, and configuration options. Because each healthcare provider has particular needs, specialties, procedures, or methods of operation that must be considered in the customization process, the solution-provider company and client healthcare provider must work together in creating a design solution. In particular, a solution-provider company typically presents a number of predetermined design decisions to the client healthcare provider company to customize a healthcare management system. Each design decision represents a particular aspect of the healthcare management system that may be customized for a particular client healthcare provider. The design decisions may present a number of options from which the client can select. In addition, a solution-provider company typically has certain design recommendations that it automatically makes to its customers. Some of these design recommendations are made for safety reasons, others may be for financial or efficiency reasons, and still other design recommendations may be made for less important reasons, for example, because a particular configuration or selection is a popular choice. Generally, the client healthcare provider must select an option or provide an answer (which may include selecting a default or recommended option) for each design decision. The solution-provider company then generates a customized healthcare management system based on selections made for the design decisions.

Because of the large number of design decisions that must be made when a healthcare management system is implemented for a particular client healthcare provider, and because different design decisions may be made by different individuals within the client healthcare provider (e.g., different clinicians, different hospital departments, etc.), design decision review is an important step in the healthcare management system design process. This is especially true for design decisions having safety-based design recommendations. Client healthcare provider's design decision choices that conflict with the design recommendations of the solution-provider company typically need to be reviewed by a responsible party at the solution-provider company, and for critical design decisions, additional review by a responsible party at the client healthcare provider may be necessary.

In accordance with embodiments of the present invention, a design decision management (DDM) system implemented over a network allows responsible parties at the solution-provider company and/or the client healthcare provider to track the status of design decisions for a particular implementation. Using the DDM system in accordance to embodiments, a responsible party could view information regarding design decisions made, design decisions not made, design decisions that conflict with design recommendations, and/or other information. In some embodiments, the responsible party could be notified automatically if certain critical design recommendations are not followed. Additionally, an online DDM system could be used to analyze data from a plurality of healthcare management system implementations. A solution-provider company could determine, among other things, which design recommendations are most often not followed and what customers' preferred configuration is for a certain design decision. Because the DDM system is online, company responsible parties could also have real-time access to design decision data of various healthcare management system implementations from any location with network access.

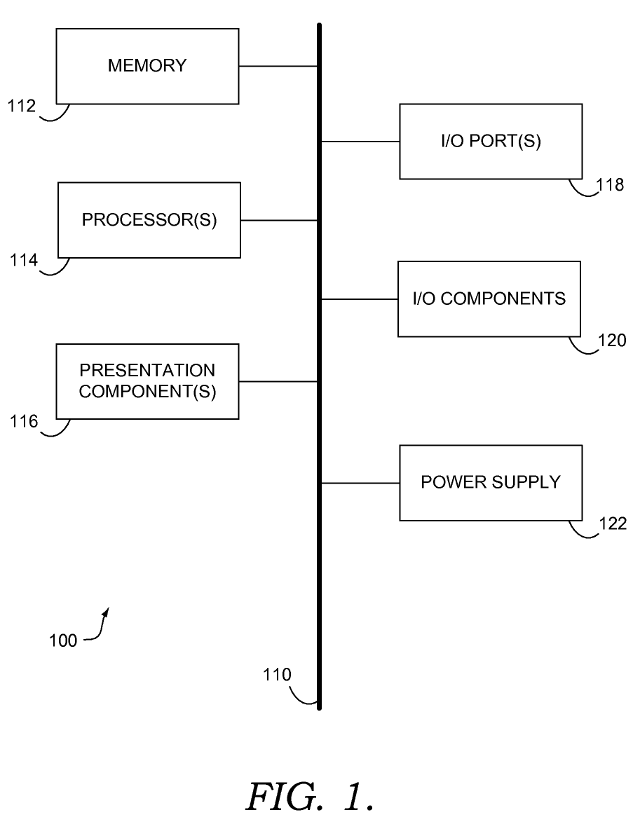

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

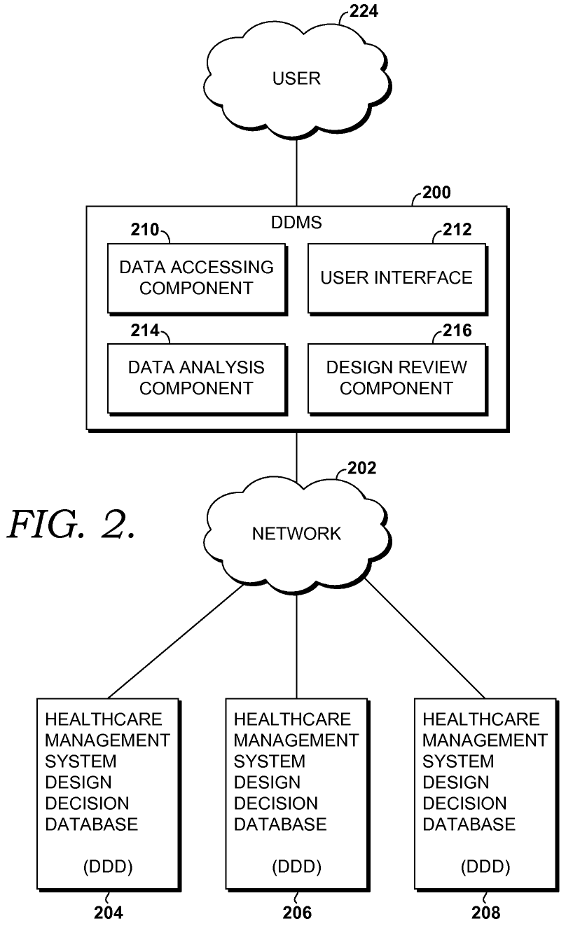

As discussed previously, embodiments of the present invention are directed to a system and method for design decision management (DDM). Embodiments of the invention will be discussed in reference to FIGS. 2-7.

A DDM system 200 is illustrated in FIG. 2. DDM system 200 is connected to network 202. Network 202 may include one or more wide area networks (WANs), one or more local area networks (LANs), one or more public networks, such as the Internet, and/or one or more private networks. Connections to network 202 may be wired or wireless. Healthcare management system design decision databases (DDD) 204, 206, and 208 are also connected to network 202. Any number of DDDs may be connected to the network.

The DDM system 200 includes a data accessing component 210 that allows the DDM system 200 to access DDDs 204, 206, and 208. Data in DDDs 204, 206, and 208 may be stored in a spreadsheet, database, or other organizational structure. Data stored in and available to be accessed from DDDs 204, 206, and 208 includes, among other data, design decisions possible, design decision recommendations, design decisions chosen, modifications since a configuration was last reviewed, identification of critical design decisions either not made or made contrary to a design recommendation, and identification of individuals responsible for implementing each healthcare management system.

The DDM system 200 also includes a user interface component 212 that allows a user, such as the user 224, to view data and control DDM system 200. In various embodiments of the present invention, the user 224 may be an individual from the solution-provider company or the client healthcare provider who is responsible for facilitating the design decision process. User 224 may sort data by category, design decision completion status, review status, or other characteristic. User 224 may access data through data accessing component 210, analyze data through data analysis component 214, and view design review status through design review component 216. In other embodiments, data accessing component 210, data analysis component 214, and design review component 216 may be controlled automatically or remotely.

In one embodiment, user interface component 212 may allow user 224 to select certain design decision items for later review by a responsible party from the solution-provider company and/or client healthcare provider. This is referred to herein as a “parking lot” feature provided by the DDM system 200. By placing design decision items in the “parking lot,” decisions may be made at a later time. The design decision items selected for later review may be presented separately in a “parking lot” view. Additionally, design decisions may be sorted based on whether or not they are to be reviewed later. Design decisions selected may be reviewed by user 224 or by other parties. User 224 may be able to select an option to view only items selected for later review. In an additional embodiment, user interface component 212 may allow either user 224 or a client to upload or link documents to the DDM system. Linked documents may contain preliminary design decisions, client procedures or goals, or other information.

In some instances, a design decision may impact a healthcare providers internal policies and procedures. In embodiments, the DDM system 200 allows decision decision items to be flagged as ones that impact policies and procedures. The user interface 212 displays design decisions whose current status indicates that a user from the client may need to review the client's internal policies and procedures. Additionally, the user 224 may be able to select an option to view only items whose status indicates that a client internal policies and procedures may need to be reviewed.

With continuing reference to FIG. 2, Data analysis component 214 may analyze trends and patterns and perform statistical analysis on information located in the DDD of various healthcare management systems. In one embodiment, user 224 may access data analysis component 214 through user interface component 212. Data analysis component 214 may perform statistical analysis regarding which design decision recommendations are routinely followed or not followed in a plurality of institutional management system implementations. Statistical analysis includes, but is not limited to, number of design decisions possible, number of design decisions made, design decision recommendations followed, design decision recommendations not followed, design decisions not made, modifications since a configuration was last reviewed, identification of critical design decisions either not made or made contrary to a design recommendation, identification of individuals responsible for reviewing particular design decisions, and identification of individuals responsible for implementing each institutional management system In another embodiment, data analysis component 214 may perform statistical analysis on an individual institutional management system.

With continued reference to FIG. 2, design review component 216 controls the design review of a particular implementation. Some design decisions may require review if a design decision recommendation is not followed. Review may be conducted by both company and client responsible parties.

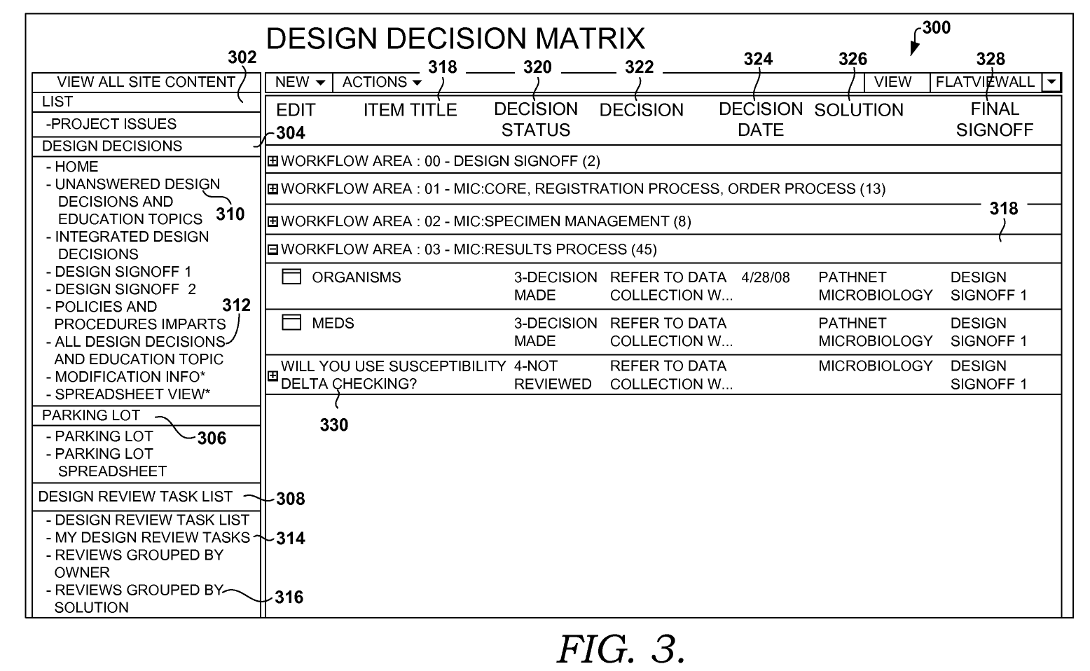

Embodiments of the present invention will now be described with reference to FIGS. 3-5, which include exemplary screen displays. It will be understood and appreciated by those of ordinary skill in the art that the screen displays of FIGS. 3-5 are provided by way of example only and are not intended to limit the scope of the present invention in any way. Referring initially to FIG. 3, a screen shot is provided illustrating a user interface 300 for viewing design decision information. In particular, user interface 300 provides a design decision matrix 301. The design decision matrix user interface 300 includes a side menu 302, which contains a design decision submenu 304, a parking lot submenu 306, and a design review task list submenu 308.

Design decision submenu 304 presents options for displaying design decisions organized in various groupings and views. For example, a user may view design decisions that have not been answered by selection option 310 “Unanswered Design Decisions and Education Topics.” Additionally, a user may view design decisions flagged as possibly impacting policies and procedures by selecting option 330 “Policies and Procedures Impacts.” Further, a user may view all decision decisions be selecting option 312 “All Design Decisions and Education Topics.”

Parking lot submenu 306 allows a user to view parking lot items—design decision items that a user has selected for consideration or review later. Design review task list submenu 308 presents options for displaying design review tasks in various groupings and views. For example, option 314 “My Design Review Tasks” allows a user to view only those design review tasks that the user has been assigned to review for a particular client hospital implementation. Alternative embodiments of “My Design Review Tasks” allow a user to view review tasks the user has been assigned across all client hospital implementations. Similarly, option 316 “Reviews Grouped by Solution” allows a user to view only those design review tasks for a particular client hospital's implementation.

With continued reference to FIG. 3, content area 318 displays the content selected by the user from side menu 302. In the present example, the content displayed in content area 318 corresponds to a selection of option 312 “All Design Decisions and Education Topics.” A listing of design decision items is provided with various attributes indicated for each design decision item. Attributes listed for each design decision in content area 318 include attribute 319 “Item Title,” attribute 320 “Decision Status,” attribute 322 “Decision,” attribute 324 “Decision Date,” attribute 326 “Solution,” and attribute 328 “Final Signoff.”

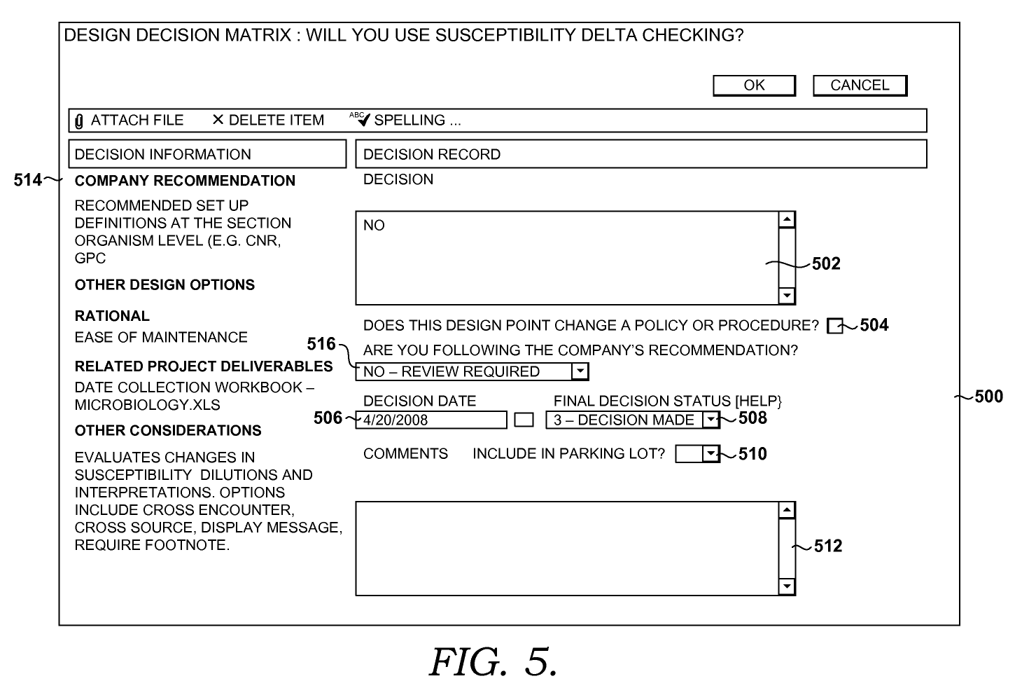

A user may select a design decision item from the design decision matrix 301 to view and/or edit details for the selected design decision item. For instance, if a user selects design decision 330 “Will you use Susceptibility Delta Checking?,” a user interface 500 such as that shown in FIG. 5 may be provided for viewing and/or editing design decision 330. The user interface 500 includes a decision input area 502 for the user to enter the client's design decision. In the present example, “no” has been entered as an answer to the design decision “will you use susceptibility delta checking.” A check box 504 is also provided for identifying the design decision choice as one that make affect a policy or procedure. “Decision Date” box 506 allows the user to indicate the date on which the design decision was made. “Final Decision Status” dropdown menu 508 allows a user to select a status. Here, a user has selected an option to indicate that a decision has been made. Other options may include “not reviewed” and “no decision.” Dropdown menu question 510 “Include in Parking Lot?” allows a user to add the design decision to the parking lot list. Data entry box 512 provides a user a place to enter comments about the design decision. Decision Information content area 514 lists the solution-provider company's recommended design solution, rationale, other design options, related project deliverables, and other considerations. Dropdown status menu 516 allows the user to indicate whether or not the client is following the company's design decision recommendation.

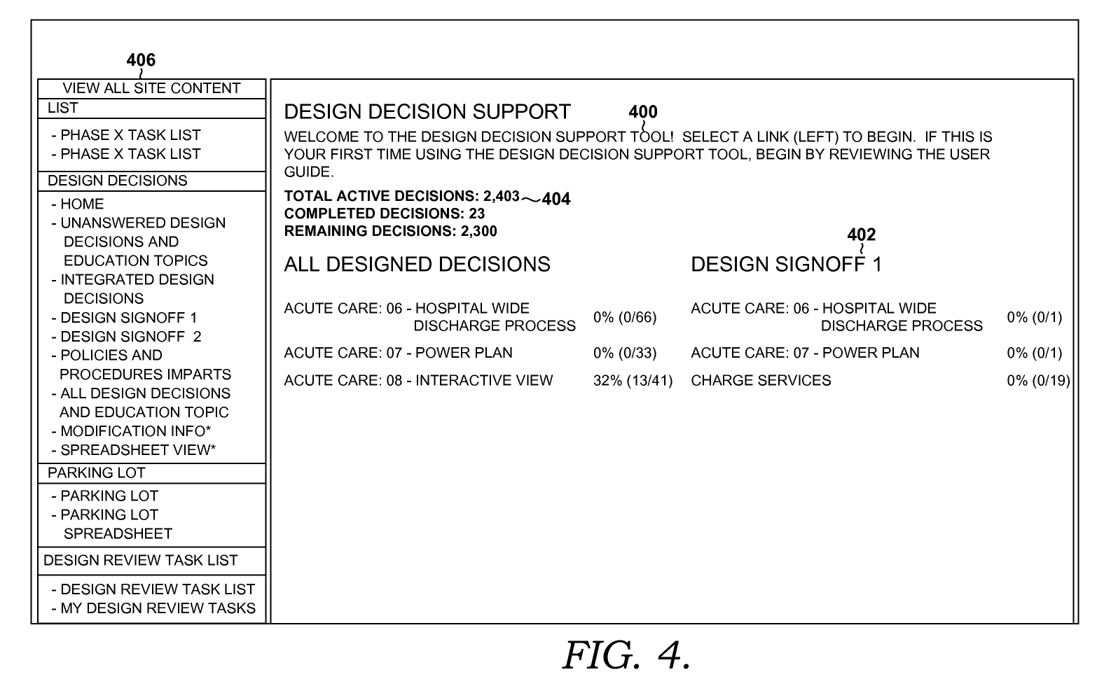

Embodiments of the present invention also provide a “dashboard” view that allows a user to quickly determine the status of a particular design process. By way of example, FIG. 4 depicts a screenshot of an exemplary dashboard view 400 in accordance with an embodiment of the present invention. The view 400 includes a content area 402 that provides a summary of various areas of design decisions. Displayed information includes decision summary 404, which displays the total number of active decisions, number of completed decisions, and number of remaining decisions. Design decisions are displayed in content area 402 by type. A percent complete is also displayed for each type. Side menu 406 displays options similar to side menu 302 (FIG. 3).

As discussed previously, the DDM system in some embodiments of the present invention facilitates the escalation and review of design decisions that conflict with recommendations. In particular, when a design decision is made that conflicts with the recommendation for that design decision item, the design decision may be escalated to individual(s) within the solution-provider company and/or the client healthcare provider, who may review the design decision.

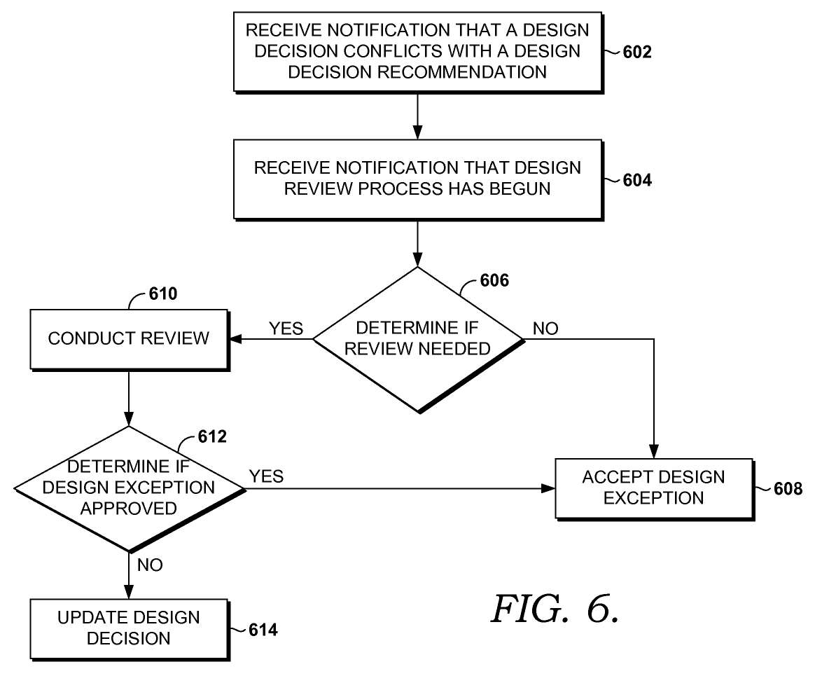

Referring now to FIG. 6, a flow diagram is provided that illustrates a method for a design review process when a design decision conflicts with recommendations for the design decision. In step 602, a responsible party associated with the solution-provider company (referred to herein as a “company response party”) receives notification that a design decision conflicts with a design decision recommendation. Because the company responsible party notified in step 602 that a design decision conflicts with a design decision recommendation may not be the person who conducts the design review, the company party responsible for the design review is notified that the design review process has begun in step 604. The company responsible party may be notified by email, through creation of a task to be completed, or through other methods. In step 606, the company responsible party determines if review is needed. Determining if review is needed may depend on the reason a particular design recommendation was made or other criteria. For example, if a particular design recommendation is safety based, the client design decision that conflicts with this recommendation may be more likely to be reviewed.

With continuing reference to FIG. 6, if review is not needed, the design exception is accepted in step 608. If review is needed, review is conducted in step 610. Review may be performed by a company responsible party and/or a responsible party associated with the client healthcare provider (referred to herein as a “client responsible party”). In step 612, a decision is made if a design exception is approved. Design exception approval comprises approval of a design decision even though that decision conflicts with a recommendation for that design decision item. If the design exception is approved in step 612, the design exception is accepted in step 608. Design decision acceptance may include additional client and/or solution-provider company review. Acceptance may be performed by changing a parameter in the DDD or through other means. If the design exception is not approved in step 612, the design decision choice is updated in step 614. Step 614 may include changing a parameter in the DDD back to the company-recommended design decision.

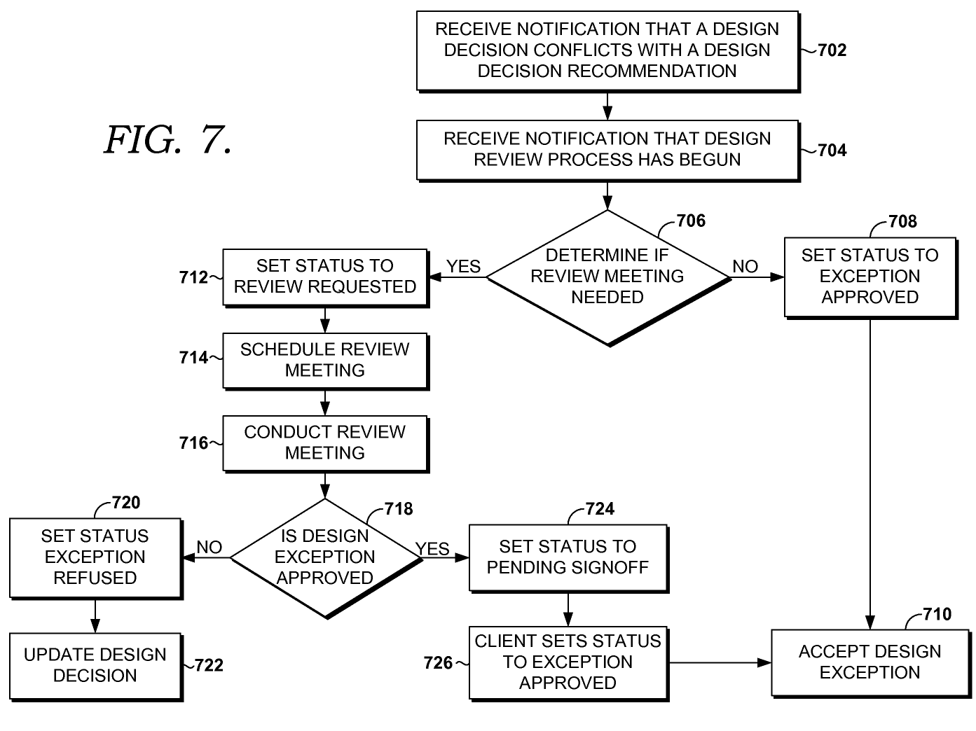

FIG. 7 illustrates another embodiment of the design review process. In step 702, a company responsible party receives notification that a design decision conflicts with a design decision recommendation. In one embodiment, a design decision could be entered in decision input area 502 of FIG. 5. Referring again to FIG. 7, in step 704, the company party responsible for review receives notification that the design review process has begun. This may be done through a parameter being changed to indicate review is initiated. In one embodiment, a design decision status parameter may be changed to indicate that the client is not following the design recommendation for that design decision and that review is requested. For example, dropdown status menu 516 in FIG. 5 “Are you Following the Company's Recommendation?” could be set to “No—Review Required.” Referring again to FIG. 7, notification in step 704 may occur via email, via assignment of a task for the company responsible party to complete, or by other methods. In addition to the at least one company responsible party, any number of other parties, including client parties, may be notified that the review process has begun.

With continuing reference to FIG. 7, in step 706, the company responsible party determines if a review meeting is needed. If the determination is made in step 706 that a review meeting is not needed, then a status parameter is set to indicate that the design exception is approved in step 708—that is, even though a client design decision conflicts with a company recommendation, the decision is allowed. In alternative embodiments, review may be conducted by an individual rather than in a meeting. In one embodiment, the status parameter may be in the DDD for the corresponding client. If a review meeting is determined not to be needed in step 706, and status is changed to exception approved in step 708, the design exception is accepted in step 710. Acceptance may be performed by changing a parameter in the DDD or through other means.

With continuing reference to FIG. 7, if a determination is made in step 706 that a review meeting is needed, a company responsible party sets a status parameter to indicate review is requested in step 712. Other company responsible parties may be notified of the design review, via email or otherwise. In step 714, a review meeting is scheduled. Scheduling may be accomplished by email, other electronic means such as a task assignment, or any other means. Other company parties or client parties may be invited to the review meeting, which is conducted in step 716. The review meeting conducted in step 716 may be conducted in person, via teleconference, videoconference, webcast, instant message, or any other way. The one or more company responsible parties decide whether or not to approve the design exception in step 718. This decision may be based upon the reason for the company design recommendation that the client's design decision conflicts with, including whether or not the design recommendation was safety based. The decision may further be based upon an understanding of the client's preferences, services offered, or business history with the company. In some embodiments, client responsible parties or client and company responsible parties may make the decision of whether the design exception is approved or not.

With continuing reference to FIG. 7, if the design exception is not approved in step 718, a status parameter may be set to indicate the exception was refused in step 720. The status parameter may be reflected in the client's DDD. The design decision choice is updated in step 722 and changed back to the company's design recommendation. Client responsible parties may be notified at any time after the design exception is not approved. If the design exception is not approved in step 718, the design review may be subject to further client review. If the design exception is approved in step 718, a status parameter may be changed in step 724 to indicate that the design exception is pending signoff. Signoff may be performed by company or client responsible parties. In one embodiment, a company responsible party sets the status to pending signoff in step 724, and a client responsible party changes the status to exception approved in step 726. The client responsible party may change the status to exception approved through the online DDM system, through accessing the client's DDD, or through another method. In other embodiments, an additional company responsible party sets a status parameter in step 726 to indicate the design exception has been approved. The design exception is accepted in step 710. Acceptance may be performed by changing a parameter in the DDD or through other means.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Because many possible embodiments may be made of the invention without departing from the scope thereof, it is to be understood that all matter herein set forth or shown in the accompanying drawings is to be interpreted as illustrative and not in a limiting sense.

What is claimed is:

1. A method for reviewing design decisions made in the implementation of a healthcare management system, comprising:
receiving notification that a client has made a design decision that conflicts with a company-recommended design decision;
receiving notification that review of the design decision has begun;
determining if review is needed;
upon determining that review is not needed, accepting the design decision as a design exception; and
upon determining that review is needed:
conducting review of the design decision,
determining if the design exception is approved,
upon determining that the design exception is not approved, updating the design decision back to the company-recommended design decision, and
upon determining that the design exception is approved, accepting the design exception.

2. The method of claim 1, wherein receiving notification that review of the design decision has begun comprises a company responsible party receiving an email or electronic task indicating review has begun and review responsibility has been assigned.

3. The method of claim 1, wherein determining if review is needed comprises determining whether the company-recommended design decision is based on patient safety concerns or financial concerns.

4. The method of claim 1, wherein the design decision is stored in a design decision database accessible over a network through an online design decision management system.

5. The method of claim 4, wherein the online design decision management system is accessible to both client responsible parties and company responsible parties.

6. The method of claim 4, wherein the online design decision management system presents the status of design decisions through status parameters.

7. The method of claim 1, further comprising a client responsible party approving the design exception before the design exception is accepted.

8. One or more computer-readable media having computer-useable instructions embodied thereon for performing a method for reviewing design decisions made in the implementation of a healthcare management system, comprising:
receiving notification that a client has made a design decision that conflicts with a company-recommended design decision;
receiving notification that review of the design decision has begun;
determining if review is needed;
upon determining that review is not needed:
setting a status parameter to reflect that a design exception is approved, and
accepting the design exception; and
upon determining that review is needed:
setting a status parameter to reflect that design decision review is requested,
conducting review of the design decision,
determining if the design exception is approved,
upon determining that the design exception is approved:
receiving client responsible party approval, and
accepting the design exception,
upon determining that the design exception is not approved:
setting a status parameter to reflect that the design exception is refused, and
updating the design decision to reflect the company-recommended design decision.

9. The computer-readable media of claim 8, wherein receiving notification that a client has made a design decision that conflicts with a company-recommended design decision comprises changing a status parameter in an online design decision management system

10. The computer-readable media of claim 8, wherein the design decision is stored in a design decision database accessible over a network through the online design decision management system.

11. The computer-readable media of claim 10, wherein the online design decision management system is accessible to both client responsible parties and company responsible parties.

12. The computer-readable media of claim 10, wherein status parameters are updated over a network connection through the design decision management system.

13. The computer-readable media of claim 8, wherein conducting review of the design decision comprises scheduling and conducting a review meeting.

14. The computer-readable media of claim 8, wherein receiving client responsible party approval comprises setting a status parameter to reflect that the design exception is pending client signoff and receiving a change of the status parameter from a client responsible party indicating the design exception is approved.

15. The computer-readable media of claim 8, wherein receiving notification that review of the design decision has begun comprises a company responsible party receiving one or more emails or electronic tasks indicating review has begun and review responsibility has been assigned.

16. The computer-readable media of claim 8, wherein determining if review is needed comprises determining whether the company-recommended design decision is based on patient safety concerns or financial concerns.

17. A design decision management system, comprising:
a data accessing component that allows a user to access design decision data stored in design decision databases over a network;
a user interface component for viewing and selecting accessed data;
a data analysis component for allowing a user to analyze accessed design decision data of multiple client healthcare management system implementations; and
a design review component for reviewing accessed design decision data that conflicts with a solution-provider company design decision recommendation.

18. The system of claim 17, wherein the user is either a solution-provider company responsible party or a client responsible party.

19. The system of claim 17, wherein the data analysis component allows a user to determine which solution-provider company design decision recommendations are most frequently not followed.

20. The system of claim 17, wherein the design review component allows for company responsible party and client responsible party review of design decisions conflicting with solution-provider company-recommended design decisions that may impact patient safety or impact client finances.
